(19) United States
(12) Patent Application Publication
(10) Pub. No.: US 2014/0290535 A1
(43) Pub. Date: Oct. 2, 2014

(54) BINDER COMPOSITION

(71) Applicants: Amutha Rani Devaraj, Barkingside (GB); Hai Xiang Lee, London (GB); Diego Alfonso Martinez Velandia, London (GB); Nikolaos Vlasopoulos, London (GB)

(72) Inventors: Amutha Rani Devaraj, Barkingside (GB); Hai Xiang Lee, London (GB); Diego Alfonso Martinez Velandia, London (GB); Nikolaos Vlasopoulos, London (GB)

(73) Assignee: CALIX LIMITED, Pymble, NSW (AU)

(21) Appl. No.: 13/820,222

(22) PCT Filed: Aug. 8, 2011
(86) PCT No.: PCT/EP2011/063629

§ 371 Date: May 8, 2013

(30) Foreign Application Priority Data
Sep. 2, 2010 (GB) 1014577.9

(51) Int. Cl. C04B 9/00; C04B 28/10; C04B 9/12

(52) U.S. Cl. CPC C04B 9/00; C04B 9/12; C04B 28/105; C04B 2111/00017
USPC 106/801

(57) ABSTRACT

New cement binders characterised by including: 30-80% by weight of a first component having MgO and at least one magnesium carbonate having the general formula: w MgC0₃.x MgO.y Mg(OH)₂.z H₂O (A) in which w is a number equal to or greater than 1; at least one of x, y or z is a number greater than 0 and w, x, y and z may be (but need not be) integers and 20-70% by weight of a second component including a least one silicon and/or aluminium oxide containing material are disclosed. They can be used to produce building materials (cements, mortars, grouts and the like) having improved structural properties relative to prior art materials. In particular, their manufacture is less energy intensive than e.g. Portland cement making them environmentally friendly in the sense that processes for their manufacture have a relatively low carbon footprint.

This invention relates to a cement binder suitable for use in construction products.

Emissions of ‘greenhouse gases’, and predominantly carbon dioxide (CO₂), are thought to contribute to an increase in the atmospheric and surface temperatures of the Earth—a phenomenon commonly referred to as ‘global warming’. Such temperature increases are predicted to have serious environmental consequences. The main contributor to this increase in man-made CO₂ is the burning of fossil fuels such as coal and petroleum.

Portland cement is the most common type of cement in general use at this time. It is an essential element of concrete, mortar and non-speciality grouts. Portland cement consists of over 90% Portland cement clinker, up to 5% gypsum and up to 5% other minor constituents. Portland cement clinker is a hydraulic material consisting mainly of di-calcium silicate (2CaO.SiO₂), tri-calcium silicate (3CaO.SiO₂), tri-calcium aluminate (3CaO.Al₂O₃) and calcium aluminoferrite (4CaO.Al₂O₃ Fe₂O₃) phases. Magnesium oxide (MgO), can also be present in Portland cement, although its amount must not exceed 5% by mass as its delayed hydration is believed to give rise to unsoundness in concrete. Gypsum (CaSO₄.2H₂O) is added to Portland cement clinker to control its setting time, and the mixture is ground to give a fine powder. On reaction with water, the constituents of the cement hydrate forming a solid complex calcium silicate hydrate gel and other phases.

The manufacture of Portland cement is a highly energy intensive process that involves heating high volumes of raw materials to around 1450° C. In addition to the CO₂ generated from burning fossil fuels to reach these temperatures, the basic raw material used in making Portland cement is calcium carbonate (limestone, CaCO₃), and this decomposes during processing to calcium oxide, releasing additional geologically sequestered CO₂. As a result, the manufacture of Portland cement typically emits approximately 0.8 tonnes of carbon dioxide for every tonne of cement produced and is responsible for approximately 5% of all anthropogenic CO₂ emissions.

Apart from the intrinsic benefit of reducing CO₂ emissions, it is likely that CO₂ emissions by the cement industry will be regulated in an attempt to reduce environmental damage. Therefore, there is a real need to develop a new range of cementitious binders that are associated with minimal or even negative CO₂ emissions.

Binders based on systems other than calcium oxide and silicates are known. For example, Sorel cement (magnesium oxychloride cement or magnesia cement) is an example of a cement binder that comprises a mixture of magnesium oxide (burnt magnesia, MgO) and magnesium chloride together with filler materials like sand or crushed stone. It sets to a very hard abrasive-resistant material and so is used for grindstones, tiles, artificial stone (cast stone) and cast floors, in which application it has a high wear resistance. However its chief drawback is its poor resistance to water, making it unsuitable for external construction applications.

Other magnesium based cements include magnesium oxysulfate cement and magnesium phosphate cements but both these have drawbacks, the former having a poor water resistance and the latter sets very fast so that it is difficult to work with.

GB 1160029 discloses cements based on mixing magnesium oxide (MgO), sodium chloride (NaCl) or sodium nitrate (NaNO₃) and calcium carbonate (CaCO₃). CaCO₃ is used as a “moderating substance” to enable the salt and the MgO to perform the chemical reactions necessary to set, which are similar to those of the other Sorel cements. These cements require the use of hard-burnt MgO, which is generally produced by high-temperature treatment (˜1000° C.) of magnesite (MgCO₃), which causes CO₂ emissions not only from the calcining of magnesite but also from the burning of fossil fuel.

U.S. Pat. No. 5,897,703 discloses binder compositions based on mixing MgO with a hardening agent, propylene carbonate. The magnesium oxide used can be any mixture of soft-burnt and hard-burnt MgO. It is known that in the presence of water, propylene carbonate decomposes to carbon dioxide and propylene glycol and so the addition of the propylene carbonate provides a source of CO₂ to carbonate the magnesium oxide.

U.S. Pat. No. 6,200,381 discloses a dry powdered cement composition derived from dolomite (a magnesium and calcium carbonate mineral; MgCO₃.CaCO₃). The dolomite is heated to decarbonate the MgCO₃ so that the composition contains CaCO₃ and a partially decarbonated MgCO₃, i.e. a mixture of MgCO₃ and MgO. Certain additives may be included in the composition (e.g. aluminium sulphate (Al₂(SO₄)₃), citric acid, sulphuric acid (H₂SO₄), NaCl, etc.), which assist the composition to set on addition of water; the water may be contaminated water, e.g. sea water. The CaCO₃ component of the cement composition reacts with several of the specified additives that are used. For example, the addition of H₂SO₄ will react with CaCO₃ yielding hydrated CaSO₄ (e.g. CaSO₄.2H₂O) and CO₂. The CO₂ released assists the carbonation of MgO and Mg(OH)₂. NaCl may be added before the thermal treatment of dolomite to decrease the decarbonation temperature of MgCO₃, and in the binder composition as an additive, where it appears to assist in achieving an early strength to the composition, which is probably due to reactions with MgO (Sorel cement type reactions). CaCO₃ acts as a “moderating substance” to enable NaCl and the MgO to perform the necessary chemical reactions (see GB 1160029 above).

U.S. Pat. No. 1,867,180 describes a cement composition based on slaked lime (Ca(OH)₂) that contains less than 1% MgO and NaCl.

U.S. Pat. No. 1,561,473 discloses that, when a wet mixture of aggregates and magnesium oxide is treated with gaseous or dissolved CO₂, its tensile strength is improved. The composition must be exposed to CO₂ when wet and the patent discloses the exposure of the wet mixture to a special atmosphere of moist CO₂.

WO 01/55049 discloses a dry powdered cement composition containing MgO, a hydraulic cement component, such as Portland cement, Sorel cements or calcium aluminate cements, and optionally various pozzolanic materials. The cement composition taught can also contain various additives such as ferrous sulphate (FeSO₄), sodium or potassium silicates or aluminates, phosphoric acid (H₃PO₄) or phosphoric acid salts, copper sulphate (CuSO₄), and various other organic polymers and resins, such as polyvinyl acetate (PVA), vinyl acetate-ethylene, styrene-butyl acrylate, butyl acrylate-methylacrylate, and styrene-butadiene. The magnesium oxide is obtained by low temperature calcining.

GB 529128 discloses the use of magnesium carbonate as an insulating material; it is made from concentrated sea water containing magnesium salts by precipitating the salts with alkali metal carbonates, which forms needle-like crystals that can set. A slurry of such crystals, when paced in a mould, will set to provide a slab or block that is useful as insulation. If there are any bicarbonate ions in the alkali metal carbonate, magnesium bicarbonate will form in the above reaction, which slows down the setting reaction. In order to counteract this, 1-5% magnesium oxide may be added, which will precipitate the bicarbonate as magnesium carbonate.

U.S. Pat. No. 1,819,893 and U.S. Pat. No. 1,971,909 both disclose the use of magnesium hydroxide or a mixture of magnesium hydroxide and calcium carbonate as an insulating material since such magnesium hydroxide is light and highly flocculated.

U.S. Pat. No. 5,927,288 discloses that a mixture of hydromagnesite and magnesium hydroxide, when incorporated into a cigarette paper, reduces side-stream smoke. The hydromagnesite/magnesium hydroxide compositions have a rosette morphology and the hydromagnesite/magnesium hydroxide mixture is precipitated from a solution of magnesium bicarbonate and possible other soluble magnesium salts by adding a strong base, e.g. potassium hydroxide.

EP 0393813 and WO 01/51554 relate to flame retardants for plastics. EP 0393813 discloses that a mixture of a double salt of calcium and magnesium carbonate (e.g. dolomite), hydromagnesite, and magnesium hydroxide can provide flame resistance to thermoplastics, e.g. a sheath of an electric wire. WO 01/51554 teaches the addition of various magnesium salts, including hydromagnesite and magnesium hydroxide, to polymers.

US 2009/0020044 discloses the capture of carbon dioxide by sea water to precipitate carbonates, which can be used in hydraulic cements; up to 10% of a pH regulating material, including magnesium oxide or hydroxide, can be added to the cement to regulate the pH.

JP 2006 076825 is concerned with reducing the amount of CO₂ emitted from power stations and by the steel industry. It proposes capturing the CO₂ by reacting with ammonium hydroxide to form ammonium carbonate:

2NH₄OH+CO₂→(NH₄)₂CO₃+H₂O

Meanwhile magnesium chloride is made by reacting magnesium oxide and hydrochloric acid:

MgO+2HCl→MgCl₂+H₂O

The magnesium chloride is reacted with the ammonium carbonate, which precipitates magnesium carbonate leaving a liquor containing dissolved ammonium chloride:

(NH₄)₂CO₃+MgCl₂→2NH₄Cl+MgCO₃

The precipitated magnesium carbonate is filtered out and used as a cement component while the ammonium chloride liquor is treated to regenerate ammonium hydroxide and hydrochloric acid.

WO 2008/148055 discloses cement compositions that include a carbonate compound composition e.g. a salt-water derived carbonate compound composition. Said compositions may also include inter alia artificial or natural pozzolans. However the compositions disclosed, consisting of three different calcium carbonates (vaterite, aragonite and calcite) and magnesium hydroxide (brucite), are different from those disclosed herein.

WO 2010/006242 discloses inter alia methods for producing various materials including pozzolans, cements and concretes from carbon dioxide and a source of divalent cations produced by digesting metal silicates. Preferably the various materials are designed to be blended into Portland cement. However there is no explicit disclosure of the improved binder compositions claimed herein or the benefits thereof.

WO 2010/039903 and WO 2010/048457 disclose reduced carbon footprint concrete compositions for use in a variety of building materials and building applications. These compositions appear to be a blend of a carbon dioxide sequestering component comprising a carbonate, bicarbonate or mixture thereof (derived from sea-water) and a conventional hydraulic cement such as Portland cement. In what is a very generic disclosure with little compositional data it is also taught the brucite (magnesium hydroxide) may be employed. Again however there appears to be no explicit disclosure of the compositions that are disclosed herein.

Our co-pending application WO 2009/156740 discloses a cement binder composition based on magnesium oxide (MgO) and special magnesium carbonates of the following form:

x MgCO₃.y Mg(OH)₂.z H₂O

wherein x is a number greater than 1, and at least one of y or z is a number greater than 0; x, y and z may be (but need not be) integers. The composition may also comprise a hydroscopic material, such as sodium chloride. The hydration of this cement composition leads to the production of a mixture of magnesium hydroxide and hydrated magnesium carbonates. Whilst this application generally teaches the optional addition of siliceous material or an aggregate, no specific teaching of the particular formulations claimed herein is made.

We have now found that the structural strength of products made with these cement binder can be unexpectedly and significantly improved at a given level of water usage by the addition of defined amounts of a further component comprising one or more silicon and/or aluminium oxide containing materials.

According to the present invention there is therefore provided a cement binder comprising:
(a) 30-80% by weight of a first component comprising MgO and at least one magnesium carbonate having the general formula:

w MgCO₃.x MgO.y Mg(OH)₂.z H₂O (A)
in which w is a number equal to or greater than 1, at least one of x, y or z is a number greater than 0; and w, x, y and z may be (but need not be) integers and
(b) 20-70% by weight of a second component comprising a least one silicon and/or aluminium oxide containing material.

Preferably the second component comprises 20-60% by weight of the cement binder, more preferably 25-45% and most preferably 25-40%. Exemplary preferred cement binders are also those which contain 40-60% by weight of the first component and 40 to 60% of the second component most preferably 45-55% of the first component and 45 to 55% of the second component.

The relative proportions of the two magnesium compounds in the first component of the cement binder will depend to a certain extent on the amount of second component employed and the degree of crystallinity of the magnesium carbonate used. With this in mind it has been found that the following broad compositional ranges produce a useful first component:
i. 10-95% of MgO
ii. 5-90% of a magnesium carbonate of Formula A.
   Within this broad envelope the following six typical composition ranges are preferred:

| Composition | | Magnesium Carbonate |
|---|---|---|
| Range. | MgO (% by weight). | (% by weight). |
| 1 | 10-30 | 70-90 |
| 2 | 30-50 | 50-70 |
| 3 | 40-50 | 50-60 |
| 4 | 50-60 | 40-50 |
| 5 | 50-70 | 30-50 |
| 6 | 70-90 | 10-30 |

The second component of the cement binder is suitably comprised of one or more silicon or aluminium oxide containing materials. These can be selected from one or more silicas, aluminas (including both physical mixtures and mixed metal oxide derivates e.g. aluminosilicates) and silicates and aluminates. If mixtures of these oxides or mixed metal oxides such as aluminosilicates are employed it is preferred that the second component has a bulk composition (by total weight) in the ranges:
i. 1-99% SiO₂
ii. 1-99% Al₂O₃
   In such cases the second component preferably comprises 20-80% SiO₂ and 20-80% Al₂O₃ most preferably 40-60% SiO₂ and 40-60% Al₂O₃.

The second component may also suitably be a pozzolanic material containing calcium, iron, sodium or potassium components, e.g. up to 40% of its total weight. The second component can conveniently be derived from typical industrial or natural materials, such as fly ash, glass waste, silica fume, rice husk ash, zeolites, fresh and spent fluid catalytic cracking catalyst, blast furnace slag, metakaolin, pumice, and the like.

Whilst not wishing to be bound by any theory, it is believed that the addition of the second component to the first enables the formation of magnesium silicate/aluminate hydrate phases during use which significantly improve the strength of any building materials made therefrom. It also helps decreases the cost and carbon footprint of both the cement and the construction products made from it. In particular it has unexpectedly been found that when the second component comprises more than 20% of the total weight of the final composition, the sample strength is increased markedly.

Whilst formula A above excludes the use of magnesite (MgCO₃) and dolomite (MgCO₃.CaCO₃) as the principal source of magnesium carbonate, the composition can contain minor amounts of these minerals, e.g. up to 25% of the total magnesium carbonate content of the composition. It is however preferred that substantially all the magnesium carbonate content of the composition is according to Formula A.

As regards the magnesium carbonates used in the first component, they preferably correspond to Formula A wherein (1) w=4, x=0, y=1 and z is zero or a number up to 4 or (2) w=4, x is greater than zero or a number up to and including 1 and y is greater than zero or a number up to and including 1 or (3) w=1, x=0, y=0, and z is a number greater than zero or a number up to and including 3. Most preferred is the use of nesquehonite (MgCO₃.3H₂O), a mixture of nesquehonite and hydromagnesite (4MgCO₃.Mg(OH)₂.4H₂O) or materials produced by the partial thermal decomposition of either. Example include 4MgCO₃.MgO which can be produced by the heat treatment of hydromagnesite (4MgCO₃.Mg(OH)₂.4H₂O) at temperatures lower than 500° C. and MgCO₃.0.5H₂O which can be produced by the heat treatment of nesquehonite at temperatures lower than 500° C. Most preferred of all is the use of nesquehonite and the thermal decomposition products thereof.

The magnesium oxide used in the first component can be either soft-burnt or hard-burnt MgO, or a mixture of soft-burnt and hard-burnt MgO. The preferred surface area of the MgO should be between 1-300 m²/g, preferably between 10-100 m²/g, more preferably between 20-70 m²/g (surface area values measured according to the Brunauer-Emmett-Teller (BET) method).

The average particle size of the magnesium carbonate used in the first component is suitably between 0.001 and 800 μm, preferably between 0.001 and 400 μm, more preferably between 0.001 and 200 μm.

The average particle size of the MgO used in the first component is suitably between 0.001 and 400 μm, preferably between 0.001 and 200 μm, more preferably between 0.001 and 100 μm.

The average particle size of the second component materials is suitably between 0.001 and 400 μm, preferably between 0.001 and 200 μm, more preferably between 0.001 and 100 μm.

The cement binder of the present invention is suitably manufactured in the form of a dry powder which can thereafter be mixed with water and optionally other ingredients such as sand and gravel or other fillers, to form a final composition comprising slurries of various consistencies that will set to form e.g. a concrete with improved structural properties. This wet composition can be made plastic and workable by the addition of plasticisers, such as lignosulfonates, sulfonated naphthalene, sulfonated melamine formaldehyde, polyacrylates and polycarboxylate ethers. Between 0 and 7.5%, preferably between 0.5 and 4% of superplasticiser (by total dry weight of the cement binder) may be also added to obtain improved properties.

Other additives which are conventional in cement, mortar and concrete technology, such as set accelerators, set retarders or air entrainers, in amounts up to 10% by dry weight of the cement binder may also be added to it or the final composition. The preferred total amount of such materials will be between 0 and 5% most preferably 0.5 and 2.5% by dry weight.

The pH of any final composition made from the cement binder can be modified during its manufacture through the use of alkalis including but not restricted to NaOH, KOH, Ca(OH)₂, and the like. These alkali materials can be added either in a solid form to the final composition or as solution in the mixing water used to make the cement paste, mortar or concrete.

Suitable aggregates and fillers which can be used with the cement binder to make the final composition comprise for example gravel, sand, glass, and other waste products. The amount of these materials can be up to as much as 99% of the total dry weight of the final composition, the exact amount depending on the expected duty of the final composition. Generally speaking, however, in most concrete, mortars and other similar compositions containing aggregates, the weight of the cement binder will be 1-70%, preferably 5-60%, more preferably 10-40% and most preferably 15-30%, of the total dry weight of the final composition.

The final composition may also optionally contain hygroscopic materials thereby allowing the water content inside the cement, mortar and concrete samples to be controlled and providing the necessary humidity for any carbonation reactions. Hygroscopic materials may include but not restricted to chloride, bromine, iodine, sulphate or nitrate salts of sodium, potassium, magnesium, calcium or iron. Due to the risk of corrosion, these salts are preferably only in compositions which will not be in direct contact with metals, such as steel-reinforcements in concrete structures.

Whilst the cement binders of the present invention can be used in association with other cement binders, e.g. Portland cement and/or calcium salts such as lime, the advantages of the present invention, especially in reducing overall carbon dioxide emissions, are reduced by doing so. For this reason the cement binder should preferably consist essentially of the first and second components defined above. If other cement binders are employed they should preferably comprises no more than 50%, preferably less than 25% by weight of the total.

As mentioned above, the cement binder of the present invention can conveniently be formulated by dry mixing the first and second components together and then sold as such for example in containers from which moisture is excluded. Alternatively, the two components may be sold separately and mixed together by the user on site as necessary and in the relative amounts desired. In a preferred embodiment the two components of the cement binder are manufactured together in a single integrated process for example one which involves the step of carbonating naturally occurring magnesium silicate ores (e.g. an olivine, a serpentine or a talc). In such an embodiment the cement binder is further characterised by being constituted from materials which are derived from the same magnesium silicate precursor and/or are derived from the same carbonation process. Such materials can comprise the various constituents of the first and second components as discrete particles, intergrowths or composite phases.

The present invention is now described with reference to the following non-limiting Examples.

In the following examples, MgO grades with a mean particle size of 15-30 μm and surface area of 30-70 m²/g were used (supplied by Premier Chemicals and Baymag). Magnesium carbonates used included hydromagnesite (4MgCO₃.Mg(OH)₂.4H₂O; supplied by CALMAGS GmbH), nesquehonite (MgCO₃.3H₂O; produced by Novacem) and thermally treated nesquehonite (MgCO₃.1.6H₂O; produced by Novacem). Second component materials used were fly ash (ex Endessa, Spain), spent fluid catalytic cracking catalyst (FCC; supplied by Omya) and glass waste powder (supplied by Castle Clays). The MgO, magnesium carbonates and the second component were initially blended by dry mixing. The resulting samples were then cast using a flow table, demoulded after 24 hrs and cured in water for 7 or 28 days at which times their compressive strength were measured using known techniques.

### EXAMPLE 1

96 g of MgO (surface area of 30 m²/g), 24 g of hydromagnesite and 80 g of glass waste powder were added to 104 g of water and mixed for 5 minutes. The mixture was cast into 10×10×60 steel moulds and cured in water. The samples achieved a compressive strength of 17 MPa after 28 days.

### EXAMPLE 2

80 g of MgO (surface area of 30 m²/g), 20 g of nesquehonite and 100 g of fly ash were added to 88 g of water and mixed for 5 minutes. The mixture was cast into 10×10×60 steel moulds and cured in water. The samples achieved a compressive strength of 29 MPa after 28 days.

### EXAMPLE 3

128 g of MgO (surface area of 30 m²/g), 32 g of hydromagnesite and 40 g of fly ash were added to 130 g of water and mixed for 5 minutes. The mixture was cast into 10×10×60 steel moulds and cured in water. The samples achieved a compressive strength of 18 MPa after 28 days.

### EXAMPLE 4

96 g of MgO (surface area of 30 m²/g), 24 g of nesquehonite and 80 g of glass waste powder were added to 94 g of water and mixed for 5 minutes. The mixture was cast into 10×10×60 steel moulds and cured in water. The samples achieved a compressive strength of 27 MPa after 28 days.

### EXAMPLE 5

80 g of MgO (surface area of 30 m²/g), 20 g of nesquehonite and 100 g of FCC were added to 94 g of water containing 2 g of superplasticiser and mixed for 5 minutes. The mixture was cast into 10×10×60 steel moulds and cured in water. The samples achieved a compressive strength of 57 MPa after 7 days and 67 MPa after 28 days.

### EXAMPLE 6

80 g of MgO (surface area of 30 m²/g), 20 g of nesquehonite and 100 g of FCC were added to 114 g of water and mixed for 5 minutes. The mixture was cast into 10×10×60 steel moulds and cured in water. The samples achieved a compressive strength of 47 MPa after 7 days and 61 MPa after 28 days.

### EXAMPLE 7

80 g of MgO (surface area of 30 m²/g), 20 g of thermally treated nesquehonite (MgCO₃ 1.8H₂O) and 100 g of FCC were added to 112 g of water and mixed for 5 minutes. The mixture was cast into 10×10×60 steel moulds and cured in water. The samples achieved a compressive strength of 37 MPa after 7 days.

### EXAMPLE 8 (COMPARATIVE)

100 g of MgO (surface area of 30 m²/g) and 100 g of FCC were added to 120 g of water and mixed for 5 minutes. The mixture was cast into 10×10×60 steel moulds and cured in water. The samples achieved a compressive strength of only 16 MPa after 28 days.

This example shows that when no hydrated magnesium carbonate is included in the cement binder significantly lower compressive strengths are obtained.

### EXAMPLE 9 (COMPARATIVE)

80 g of MgO (surface area of 30 m²/g) and 20 g of nesquehonite were added to 70 g of water and mixed for 5 minutes. The mixture was cast into 10×10×60 steel moulds and cured in water. The samples achieved a compressive strength of only 17 MPa after 28 days.

In this example the cement binder contains no second component. A significantly lower compressive strength is obtained.

1. A cement binder characterised by comprising:
(a) 30-80% by weight of a first component comprising MgO and at least one magnesium carbonate having the general formula:
w MgCO₃.x MgO.y Mg(OH)₂.z H₂O (A)
in which w is a number equal to or greater than 1, at least one of x, y or z is a number greater than 0, and w, x, y and z may be, but need not be, integers; and
(b) 20-70% by weight of a second component comprising a least one silicon and/or aluminium oxide containing material.

2. The cement binder as claimed in claim 1, wherein each of said components comprise 40-60% by weight.

3. The cement binder as claimed in claim 2, wherein each of said components comprise 45-55% by weight.

4. The cement binder as claimed in claim 1, wherein the said first component comprises 10-95% by weight MgO and 5-90% by weight magnesium carbonate.

5. The cement binder as claimed in claim 1, wherein the first component comprises 10-30% by weight MgO and 70-90% by weight magnesium carbonate.

6. The cement binder as claimed in claim 1, wherein the first component comprises 40-50% by weight MgO and 50-60% by weight magnesium carbonate.

7. The cement binder as claimed in claim 1, wherein the first component comprises 30-50% by weight MgO and 50-70% by weight magnesium carbonate.

8. The cement binder as claimed in claim 1, wherein the first component comprises 50-60% by weight MgO and 40-50% by weight magnesium carbonate.

9. The cement binder as claimed in claim 1, wherein the said first component comprises 50-70% by weight MgO and 30-50% by weight magnesium carbonate.

10. The cement binder as claimed in claim 1, wherein the said first component comprises 70-90% by weight MgO and 10-30% by weight magnesium carbonate.

11. The cement binder as claimed in claim 1, wherein the magnesium carbonate is selected from nesquehonite, the thermal decomposition products of nesquehonite or a mixture of nesquehonite and the thermal decomposition products of hydromagnesite and/or nesquehonite.

12. The cement binder as claimed in claim 1, wherein the second component comprises 40-60% Si02 and 40-60% Al₂O₃ based on its total weight.

13. The cement binder as claimed in claim 1, wherein the second component comprises at least one aluminosilicate.

14. The cement binder as claimed in claim 1, wherein the first and second components are made from the same magnesium silicate precursor.

15. The cement binder as claimed in claim 14, wherein the first and second components are derived from the same carbonation process.

16. The cement binder as claimed in claim 14, wherein the magnesium silicate precursor employed is an olivine, a serpentine or a talc.

17. Concrete wherein it is manufactured from the cement binder of claim 1, aggregate and additives.

18. The concrete as claimed in claim 17, wherein at least one of the following additives are used: plasticisers, superplasticisers, set accelerators, set retarders and air entrainers.

19. The concrete as claimed in claim 18, wherein a superplasticiser is used in an amount corresponding to between 0.5 and 4% of the dry weight of the cement binder.

20. (canceled)
